(19) United States
(12) Patent Application Publication
(10) Pub. No.: US 2024/0354501 A1
(43) Pub. Date: Oct. 24, 2024

(54) ENHANCED MAIL OPERATIONS USING LARGE LANGUAGE MODELS

(71) Applicant: YAHOO ASSETS LLC, New York, NY (US)

(72) Inventors: Bassem BOUGUERRA, New York, NY (US); Kevin PATEL, New York, NY (US); Joshua JACOBSON, New York, NY (US); Shashank KHANNA, New York, NY (US); Shiv SHANKAR, New York, NY (US); Kenneth SEBASTIAN, New York, NY (US); Renganathan DHANAGOPAL, New York, NY (US); Bryan WONG, New York, NY (US); Miodrag KEKIC, New York, NY (US); Suraj UPRETI, New York, NY (US); William HO, New York, NY (US)

(21) Appl. No.: 18/643,568

(22) Filed: Apr. 23, 2024

Related U.S. Application Data
(60) Provisional application No. 63/497,944, filed on Apr. 24, 2023.

(51) Int. Cl. G06F 40/205; H04L 51/04

(52) U.S. Cl. CPC G06F 40/205; H04L 51/04

(57) ABSTRACT

The example embodiments are directed toward leveraging the power of large language models (LLMs) in a messaging application. In a first embodiment, LLMs are utilized to generate message content (both original and reply). In a second embodiment, LLMs are utilized to provide enhanced semantic search functionality. In a third embodiment, LLMs are utilized to provide intelligent actions to take based on message content.

### CROSS-REFERENCE TO RELATED APPLICATIONS

This application claims the benefit of U.S. Prov. App. No. 63/497,944, filed Apr. 24, 2023 and incorporated by reference in its entirety.

### BACKGROUND

Current messaging (e.g., email, chat, text) application store fast amount of data. Users frequently interact with such applications on a near constant basis. However, most messaging applications are limited in functionality primarily due to basic information retrieval systems used to implement the applications.

### BRIEF DESCRIPTION OF THE DRAWINGS

FIG. 1 is a flow diagram illustrating a method for creating a message using an LLM within a messaging client.

FIGS. 2A through 2G are screen diagrams illustrating a method for creating a message using an LLM within a messaging client.

FIG. 3 is a flow diagram illustrating a method for performing a semantic search in a messaging application using LLMs.

FIGS. 4A through 4D are screen diagrams illustrating a method for performing a semantic search in a messaging application using LLMs.

FIG. 5 is a flow diagram illustrating a method for extracting actions from messages.

FIGS. 6A through 6B are screen diagrams illustrating a method for extracting actions from messages.

FIGS. 7A through 7B are screen diagrams illustrating a method for extracting actions from messages.

FIG. 8 is a block diagram illustrating a computing system according to some of the example embodiments.

FIG. 9 is a block diagram of a computing device according to some embodiments of the disclosure.

### DETAILED DESCRIPTION

In a first embodiment, the disclosure describes techniques for augmenting a messaging (e.g., electronic mail) application to provide automatic text generation for common tasks.

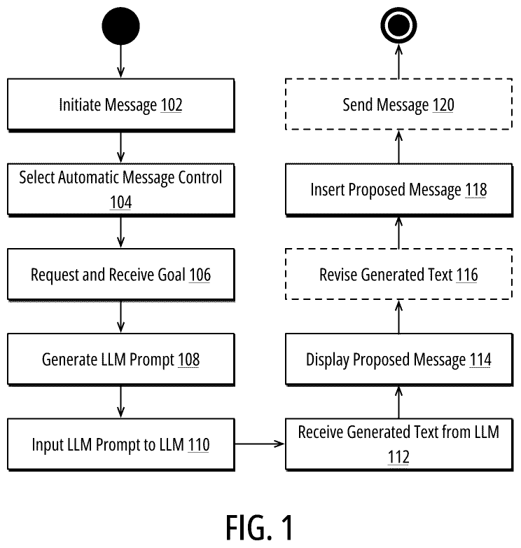

FIG. 1 is a flow diagram illustrating a method for creating a message using an LLM within a messaging client.

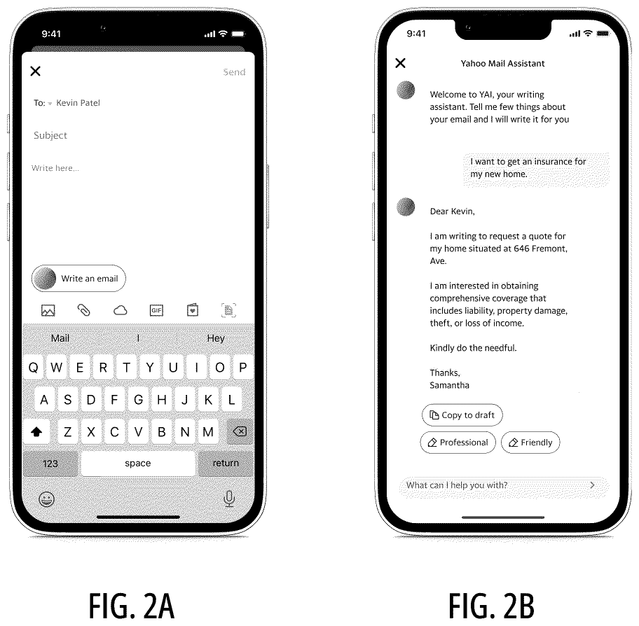

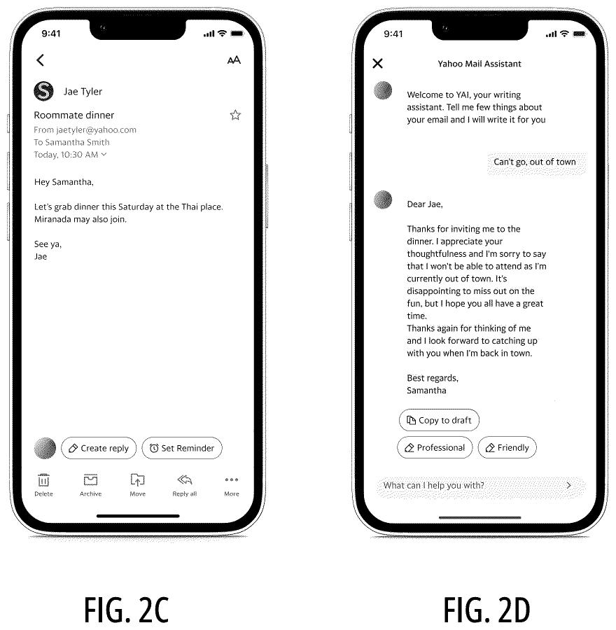

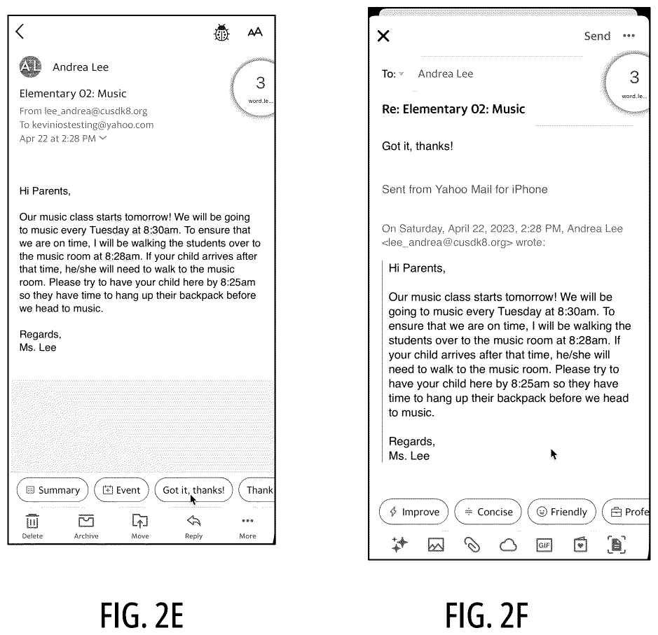

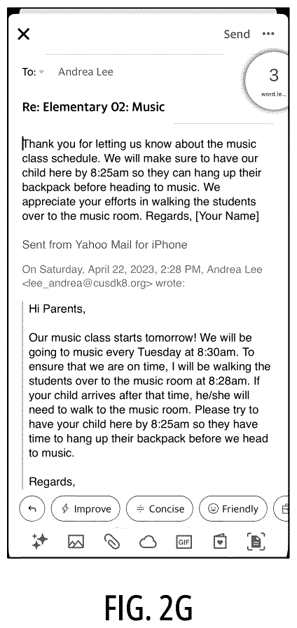

In step 102, the method can include initiating a message. In some implementations, the message can comprise an email, short message service (SMS) message, chat message, or other type of message content. Although email is utilized as an example, the disclosure is not limited as such. Further, although text is primarily described, the disclosure may utilize other types of content such as audio or video content. In some implementations, step 102 can include generate a blank message as illustrated in FIG. 2A. In some implementations, the user can pre-fill some or all the content when initiating the message. For example, as illustrated in FIG. 2A, the user may insert a recipient name or address (e.g., email address). As another example, the user may also input a subject or may start to write a portion of the message.

In step 104, the method can include selecting a control to automatically create a message. As illustrated, for example, a control (“Write an email”) may be displayed in the user interface of the messaging client that allows a user to create a new message from an initiated message. The specific type of control is not limiting.

In step 106, the method can include requesting the user provide a message goal and receiving a goal from the user. As illustrated in FIG. 2B, in response to the selection of the control, the method can display a chat interface. The chat interface can present a default cue which prompts the user to provide a goal for the new message. In response, the user can provide the goal in the chat interface. For example, FIG. 2B illustrates a goal of “I want to get an insurance [quote] for my new home.”

In step 108, the method can include generating an LLM prompt using the goal. As used herein, an “LLM prompt” refers to the text string input into an LLM to generate an output (as compared to general prompting). In some implementations, the LLM prompt can be equal to the goal. In other implementations, the LLM prompt can be constructed by inserting the goal into an LLM prompt template which includes leading or trailing text used to guide the LLM. In some implementations, the LLM prompt can be dynamically defined based on the initiated message and/or data of the user. For example, the recipient, subject, and/or initial content can be added to the prompt. Further, a user's message history, or demographic data, can be used to create a prompt.

The specific ways in which this data can be used is not limiting. As one example, the messaging client can determine that the recipient (“Kevin Patel”) has never received a message from the user and based on this determination can adjust the prompt to include guidance (e.g., “I'm writing an email to Kevin Patel, who I'm not familiar with . . . ”) before completing the LLM prompt (e.g., “Please draft an email to get insurance for my new home.”). Other types of conditional logic may be used to engineer LLM prompts. In some implementations, the LLM prompt can also be augmented with a past history of messages or other content relevant to the conversation. For example, the messaging client can build a prompt by copying past replies to guide the LLM to generate a message matching the style of past messages.

In some implementations, the goal can be parsed to identify LLM prompt keywords. For example, the goal of “I want to get an insurance [quote] for my new home” can be parsed to extract entities or other objects. In some implementations, the LLM (access to which is discussed next) can be used to extract entities from the goal. For example, a separate LLM prompt requesting the LLM to identify entities within the goal can be issued. For example, this type of LLM prompt can state: “Given available properties of (home, name, email, gender, interests), please identify which appear in the following text: I want to get an insurance for my new home.” Certain the properties are limited and only examples, more may be used and these properties may be based on the user profile or other data. In response, the LLM may return the property found in the text (“home”) which can be used to query a user profile for the user's address (“646 Fremont Ave.”). This data can then be used to augment the LLM prompt.

In some implementations, the LLM prompt can include further data defining the output of the LLM. For example, the LLM prompt can include standard text requesting that the output be formatted as an email or can include the name of the user (from the user profile) to use as a signature.

Tying the above examples together, one example of such a prompt using the above embodiments may be:
Draft a message based on this goal: I want to get an insurance for my new home. Please use the following properties when writing the message:
My name: Samantha
Recipient name: Kevin
Home Address: 646 Fremont Ave.
The message should be limited to two paragraphs. Message:

In step 110, the method can include inputting the LLM prompt into an LLM. In some implementations, step 110 can include transmitting the LLM prompt over a network to a centralized LLM via an application programming interface (API) or similar endpoint. In some implementations, the LLM may be executing locally on the device executing the messaging client. In such a scenario, the LLM prompt may be input locally into the local LLM. In either scenario, step 110 can also include adjusting parameters of the LLM (e.g., temperature) based on user preferences, historical values, or other heuristics.

In step 112, the method can include receiving generated text from the LLM responsive to the LLM prompt. In some implementations, the generated text may be returned from a network endpoint or from a locally running LLM.

In step 114, the method can include displaying the generated text as a proposed message. As illustrated in FIG. 2B this proposed message can be displayed in a chat interface or similar type of ephemeral display. In some implementations, the chat interface can include a text input that allows the user to issue arbitrary commands to the LLM after receiving the proposed message. For example, the user can instruct the LLM via subsequent LLM prompts how to adjust the message. No limit is placed on this type of modifications.

In step 116, the method can include optionally revising the proposed message in response to a user input. As discussed above, in a first example, this revision can take the form of a subsequent LLM prompt (“please make the message shorter”) received directly from the user. Alternatively, the chat interface can provide dedicated controls for adjusting the message according to standard revision approaches. For example, the chat interface in FIG. 2B illustrates two such controls: “Professional” and “Friendly,” which cause the messaging application to generate subsequent LLM prompts to make the proposed message sound more professional or friendlier, respectfully. In some implementations, these controls can be tied to template LLM prompts (e.g., “Make the previous message sound more professional”) that can be issued to an LLM.

In step 118, the method can include inserting the proposed message (or revised proposed message) into the initial message. In some implementations, the chat interface can include a control (“Copy to draft”) that automatically inserts the most recent proposed message into the initial message. In some implementations, the user can alternatively manually copy and paste the message into the initial message.

Finally, in step 120, the method can include sending the LLM-generated message to the recipient. Certainly, the user may further edit or revise the message as needed and these and the sending process can be implemented via standard messaging techniques.

The foregoing method of FIG. 1 may be modified to support generating LLM-generated replies in addition to creating messages. FIG. 2C illustrates a view of the messaging application that is displaying a received message. In the interface, a “Create reply” control is displayed which, when selected, will display the chat interface displayed in FIG. 2D. As illustrated, the chat interface may receive a goal (“Can't go, out of town”), can generate an LLM prompt, and can provide a proposed message based on the generated text output by the LLM (“Dear Jae . . . ”). Some of all of the techniques used to generate the LLM prompt described in FIG. 1 may likewise be applied in the context of generating replies. However, in some implementations, the LLM prompt for replies may always (but is not required to) include the original message. Thus, one example LLM prompt may be:
I received this message from Jae Tyler and would like to respond:
Subject: Roommate Dinner
Content: Hey Samantha, Let's grab dinner this Saturday at the Thai place. Miranada may also join. See ya, Jae
Use the following properties when preparing the response:
Relationship: Friend
Tone: Personal
Contact Frequency: Often
Please draft a response stating: Can't go, out of town.
Message:

It should be noted that entity extraction may be omitted when replying given the LLM is capable of identifying entities (“Miranada,” “Thai place,” etc.). As illustrated, the chat interface may also provide controls for refining the message via defined supplemental LLM prompts or via freeform user-supplied LLM prompts. Likewise, the chat interface allows the user to copy the proposed response directly into the message as a response.

FIG. 2E illustrates an alternative embodiment wherein a method can include predicting a response based on the content of a message. In the illustrated embodiment, the method can include receiving and displaying a message from a recipient. In the message view, the messaging application can display controls allowing the user to input predicted responses (e.g., “Got it, thanks,” “Thank you”). In some implementations, these controls can be generated by inputting an LLM prompt into an LLM, the LLM prompt including the message text. For example, the LLM prompt can include the message and a prompt asking the LLM to generate a set of potential responses.

In some implementations, the user can select one of the controls and the messaging application will insert the pre-generated response as a reply. For example, the user in FIG. 2E may select the highlighted control (“Got it, thanks”) which creates a reply illustrated in FIG. 2F that inserts the text “Got it, thanks” in the reply. As discussed in the previous method and user interfaces, the messaging application can then display controls which can be used to revise the message. For example, the controls “Improve,” “Concise,” “Friendly,” “Professional,” “Add Emojis,” etc. Each of these controls may be associated with an LLM prompt template that can be input to an LLM to revise the current message. For example, the “Friendly” LLM prompt template may be:
Given the message <message> and my current response <response>, please revise the response to make it sound more friendly.

Here <message> may be the received message text and <response> may be the current response in the messaging application.

In some implementations, the method can further include modeling the user based on past data of the user. For example, the method can utilize the user's activity within a messaging application, the user's past messages, the user's calendar, the user's task list, the user's notes, and any other data to profile the user. This data can be used to profile the user and assign the user to one or more cohorts which can then be used to augment the LLM prompt to improve the suggested responses. For example, a user may be placed in a “short response” cohort based on the length of past replies, or may be placed in a “always busy” cohort based on their calendar events. Then, in response to a message to set up a meeting, the LLM can receive these cohorts that will guide the LLM to output contextually relevant responses (e.g., “ok great” or “let me check my calendar”). As another example, the user's notes can be converted to embeddings and an embedding of the received messages can be used to identify the most relevant notes. Then, if the notes can be added to the LLM prompt to guide the LLM. For example, if the user receives a message asking if they would like anything from the grocery store and the user has a note with groceries, the LLM may output a suggestion that incorporates the note into the response. In some implementations, the system can utilize a “next action” model that can predict what a user may do in response to message. These suggested actions can be included in the LLM prompt when identifying a potential response.

As illustrated next in FIG. 2G, the method can then receive the response from the LLM and replace the current reply with the revised reply based on the output of the LLM. In some implementations, the text in FIG. 2G (and in other instances where LLM-generated text is displayed) can be streamed to the messaging application. In this scenario, each word can be rendered sequentially as it is output by the LLM improving the user experience and enabling quicker understanding of the LLM output.

In some implementations, a messaging application may further use an LLM to augment search capabilities of the application. Currently, most search functionality in messaging applications is limited in nature, comprising basic keyword matching and retrieval of messages. Some systems employ fuzzy searching or similarity searching, however these approaches generally are limited to displaying a list of relevant messages. The next embodiments improve the technical capabilities of search systems by leveraging the power of LLMs and the closed nature of the messaging corpus to provide meaningful answers to questions posed via search.

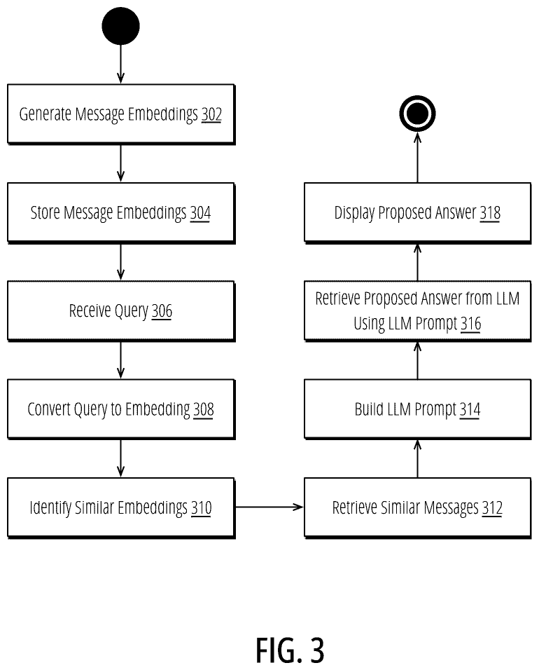

FIG. 3 is a flow diagram illustrating a method for performing a semantic search in a messaging application using LLMs.

In step 302, the method can include generating embeddings from a user's message list (e.g., inbox) using a text-embedding model. In some implementations, the method can include generating vectors or other types of text embeddings of each message a user has received. In some implementations, the method can include receiving a vector of floating-point values representing each message. In some implementations, the method can utilize a network API for accessing an embedding model which can generate the embeddings for each message.

In step 304, the method can include storing the embeddings for a user. In some implementations, the embeddings may be stored by a message provider (e.g., in a central repository). In general, each user may be associated with their own database of embeddings. In some implementations, this database can be synchronized with a user's messaging application. In other implementations, the database may remain remote from the messaging application. In some implementations, the method can include updating the embedding database as new messages are received. That is, each new message can be converted into an embedding and stored in the embedding database. In some implementations, the embeddings are associated with message identifiers and thus when a user deletes or otherwise modifies a message, the corresponding embedding can be appropriately deleted or modified, respectively.

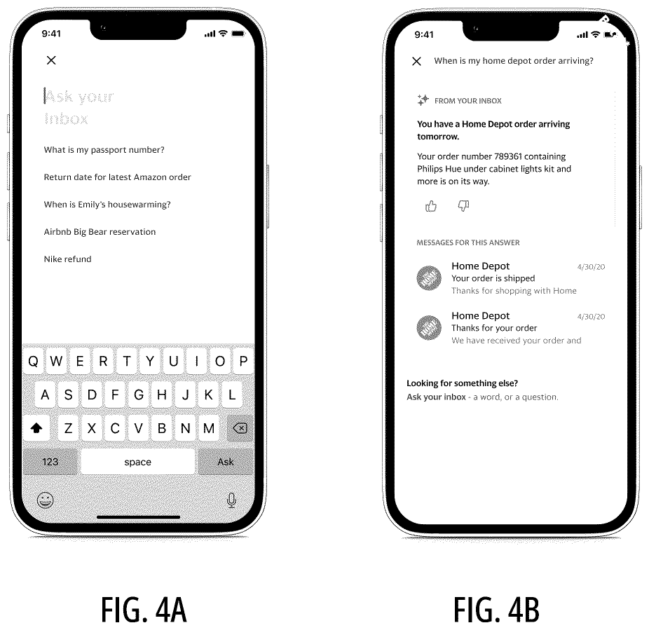

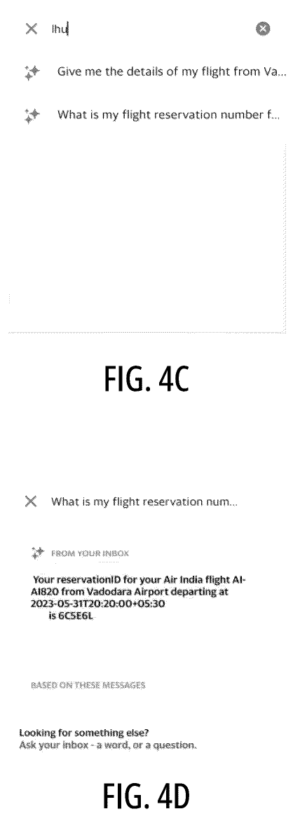

In step 306, the method can include receiving a query. As illustrated in FIG. 4A, the method can provide a text input or other type of input (e.g., voice, camera, etc.) to receive a query from a user (e.g., “When is my Home Depot order arriving”). No limit is placed on the form of the query and any wording may be used.

In some implementations, the query can comprise a word or phrase and the method can include selecting a pre-generated query based on the word or phrase. In some implementations, a user's messages can be analyzed upon receipt. In some implementations, this analysis can include extracting entities (e.g., product data, flight numbers, etc.) from the messages. These entities can then be used to generate one or more pre-generated questions possible for the message. As a first example, the pre-generated questions can be static. That is, for each type of entity a set of standard questions can be associated with the entity. As a second example, the entities can be included in an LLM prompt requesting a list of questions and the LLM prompt can be input to an LLM to retrieve potential questions. In some implementations, the questions can be indexed based on the entities. Then, when a user enters a query, the query can be used to find a matching entity (e.g., either via index traversal or via embedding similarity). Then, the resulting pre-generated questions can be provided to the user.

As an example, FIG. 4C illustrates a user entering the term “LHU” which may correspond to a travel entity (e.g., airport code, airline moniker, etc.). In response, the messaging application can present pre-generated questions (“Give me the details of my flight . . . ” and “What is my flight reservation number . . . ”). In response, as illustrated in FIG. 4D, a user can select the pre-generated question and continue with the method (generating an answer, as will discussed).

In step 308, the method can include converting the query into an embedding. In some implementations, the same embedding model used in step 302 may be used in step 308. In some implementations, the method can include the message application transmitting the query to a server which in turn generates the embedding.

In step 310, the method can include identifying the embeddings in the embedding database that are most similar to the query embedding. In some implementations, the embedding database may support similarity searching (e.g., cosine similarity) to allow the server to issue a query to the embedding database using the query embedding. In response, the embedding database will return a ranked list of the most similar embodiment embeddings. In some implementations, step 310 can include selecting a subset of these ranked embeddings and using this subset as the most similar embeddings. The specific number of embeddings selected is not limiting and may be tuned based on the properties of the LLM (discussed next) or other considerations.

In step 312, the method can include retrieving the messages associated with the most similar embeddings. As discussed above, each embedding can be associated with a message identifier that allows the system to retrieve the message used to generate the embedding. As a result, the system can extract the messages associated with the embeddings.

In step 314, the method can include building a prompt using the original query and the most similar messages corresponding to the most similar embeddings. In some implementations, an LLM prompt template can be used, such as:
Given the following relevant messages:
<messsage for message in messages>
Generate an answer for the following query: <query>

Here, the LLM prompt template can iterate through the most similar messages to include the full text as well as metadata (e.g., subject, date, sender, etc.) and then insert the text query into the LLM prompt.

In step 316, the method can include inputting the LLM prompt into an LLM and receiving a proposed answer. In some implementations, the proposed answer may comprise a text string comprising the answer to the query. In other scenarios, the proposed answer may comprise a response indicating no answer was found.

In step 318, the method can include displaying the proposed answer and the most similar messages. As illustrated in FIG. 4B, the display may include the proposed answer as well as a ranked list of messages. This ranked list of messages may correspond to the most similar messages used to generate the LLM prompts. As illustrated in FIG. 4B, a query “When is my Home Depot order arriving?” can be converted into a prompt such as:
Given the following messages:
#Message 1
From: Home Depot
Subject: Your order is shipped
Date: Apr. 30, 2020
Content: Thanks for shopping with Home Depot. Your order (#789361) containing 2× Phillips Hue Under Cabinet Lights Kit has shipped and will arrive tomorrow.
#Message 2
From: Home Depot
Subject: Thanks for your order
Date: Apr. 30, 2020
Content: We have received your order containing 2× Phillips Hue Under Cabinet Lights Kit has shipped and are preparing it.
Answer the following query: When is my home depot order arriving?

In some implementations, the answer may include both the LLM output as well as content extracted from the most relevant message. For example, the text “You have a Home Depot order arriving tomorrow” may comprise the LLM output while the following text may be extracted from the highest-ranking message as supplemental answer content. In other scenarios, the entire LLM output may be used as the answer.

In some implementations, the LLM can be configured to interact with an agent configured to query a set of user messages as part of an LLM toolchain. The interaction between the LLM and agent in the LLM toolchain can be a multi-step process. First, the agent queries a set of user messages and extracts relevant information. Next, the agent passes this information to the LLM for processing. The LLM uses its language understanding capabilities to analyze the input and generate a response. Finally, the agent receives the response from the LLM and can deliver it back to the user. This process can be repeated iteratively, allowing the LLM to learn and adapt to the user's language patterns over time. This approach can be particularly effective in applications where users interact with language models in a conversational manner, such as chatbots or voice assistants.

As one example, the initial user query can be input into an LLM to classify the query (e.g., “travel”-related). Then, the message agent can be configured to extract all travel-related emails (based on a pre-computed index of messages) which can then be used as the closed environment for a subsequent LLM query (as discussed above).

The foregoing examples are not limited to a search agent. Indeed, other agents can be used alone or in conjunction with a search agent. For example, a date engine can be executed by the LLM toolchain when a date or date range is detected in a given user query. Such an agent may return a limited corpus of the total message content based on the date or date range. Further, an aggregation agent can be used which can determine when a given query requests an aggregated response. For example, a query “How many orders have I placed on Amazon this month” employs both a date engine (“this month”) and an aggregation agent (“how many orders”). As a result, the general-purpose LLM may be fed with a single document: an aggregated report of all Amazon orders for the current month and the prompt (“How many orders have I placed on Amazon this month”). Thus, these two agents (and others) can augment the general LLM capabilities by limiting the universe of data used by the general LLM architecture to generate text.

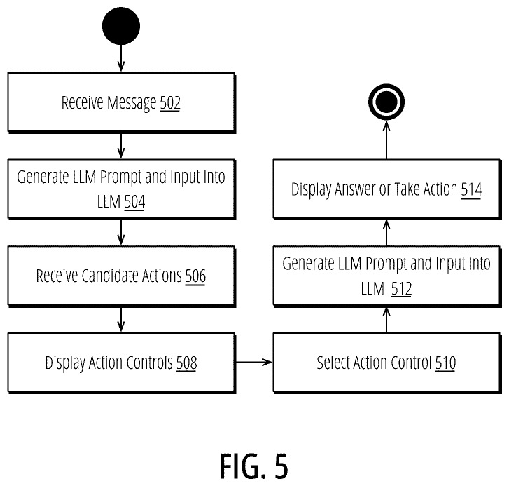

FIG. 5 is a flow diagram illustrating a method for extracting actions from messages.

In step 502, the method can include receiving a message. As discussed, a message may be an email, text message, chat message, or generally any type of message that can be represented as text. In some implementations, a messaging application may receive the message when displaying one or more messages to a user.

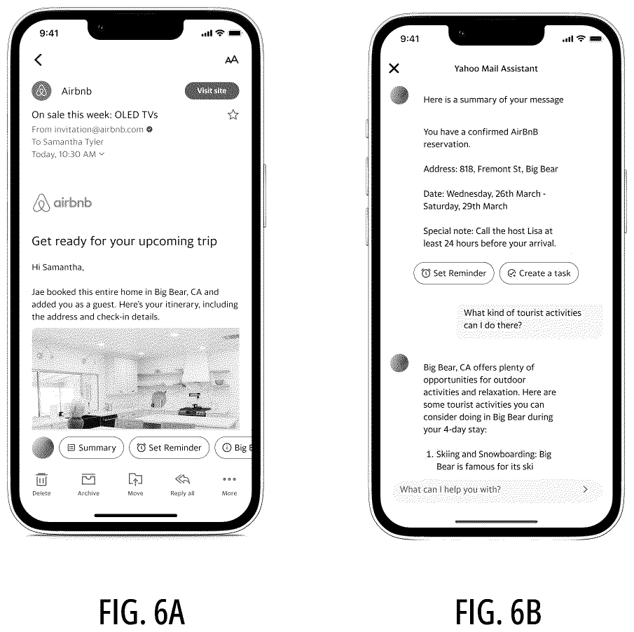

One such messaging application is depicted in FIG. 6A. Here a user has received a message from Airbnb® including content related to an upcoming trip. As illustrated, in some implementations, step 502 can include displaying a plurality of controls (e.g., “Summary,” “Set Reminder,” “Big Bear.” These controls may be selectable by the user. The specific number of controls is not limiting, and the specific content is not limited. Indeed, as will be discussed next, an LLM can be used to generate the text and subsequent LLM prompt (i.e., actions) that are associated with the message.

In step 504, the method can include generating an LLM prompt based on the message and inputting the LLM prompt into an LLM. In an implementation, the method can include extracting the text and/or metadata of the message and building an LLM prompt that directs an LLM to construct a set of actions to use when building controls (such as those illustrated in FIG. 6A).

In some implementations, the LLM prompt can comprise a preamble instruction portion that is augmented with the message content. In some implementations, the preamble can define the structure of the desired output. In some implementations, the preamble can provide an explicitly list of supported action types (e.g., calendar events, task list items, message actions such as replying or forwarding, etc.) as well as a request for general entities within the message. One example of such a preamble is provided below, but the disclosure is not limited as such:
You are a signal-identifying agent tasked with identifying actions within a message. The actions supported are “Add a calendar event” and “Add a task item.” Additionally, entities (e.g., people, places, or things) from the message may be extracted.
Please respond only with a JSON object having the form:

{″actions″:[ ″type″ : <<calendar|task>>,
″description″: <<summary>>...],
″entities″: [<<entities>>] }

Please identify any signals in this message: <<message>>

The above preamble defines two well-defined action types (calendar and task) as well as a request for any entities. The preamble also requires the LLM output a properly formatted JSON object which may then be used to build the controls illustrated in FIG. 6A.

In step 506, the method receives the candidate actions as output by the LLM in response to the LLM prompt. As a continued example, the above prompt, applied to the message in FIG. 6A may return the following answer:

```
{
  “actions”: [
    { “type” : “calendar”, “description”: “Set Reminder” },
    { “type”: “task”, “description”: “Create a task” }
  ],
  “entities” : [ “Big Bear, CA” ]
}
```

In some implementations, the resulting actions can be combined with global actions. For example, a global “Summarize” action may be applied to all messages and is not dependent on the LLM output.

In step 508, the method can include displaying action controls in response to the candidate actions. In some implementations, the messaging action can parse the output of the LLM to generate UI controls such as those depicted in FIG. 6A. In some implementations, each control can be associated with a subsequent LLM prompt template. For example, the global “Summarize” action can be associated with the following prompt:
Please summarize the following message: <<message>>

Actions output by the LLM may be processed more than global actions. For example, as a threshold matter, the messaging application may prioritize some actions over the other. In some implementations, the LLM prompt used to generate the action can be augmented to request the LLM gauge the relevance of the entities and/or actions which can then be used to rank the actions or entities. The messaging application can then select the top N actions or entities to limit clutter of the UI. In some implementations, the messaging application can select all actions and then filter the entities using this approach.

Next, the method can iterate through the actions and entities and build subsequent LLM prompts. For example, each action type can be associated with domain-specific prompts. This specificity may be defined based on the receiving application. Thus, a calendar application may expect certain data (e.g., date, time, title, locations, invitees, etc.) while a task application may expect different data (e.g., task, due date). Thus, each action can have its own LLM prompt. As one example, a calendar LLM prompt may be:
Generate a data structure used for calendaring the following message: <<message>>.
The data structure should be a JSON object having the properties of date (required), time, title (required), and location (string). Only return the JSON:

Similarly, a task prompt may be:
Generate a data structure used for creating a task item for the following message: <<message>>.
The data structure should be a JSON object having the properties of task (required), due date (required).

For entities, the method may use a general entity prompt. For example, the prompt: “Provide a description of the following entity (<<entity>>) in the context of this message: <<message>>.” In some implementations, entities may be classified and classified templates can be used (e.g., “Provide some details on this location including things to do” for location entities).

Notably, the use of LLM allows for the extraction of more nuanced actions and entities as compared to existing natural language processing techniques as it accounts for human language representations of such items.

As illustrated in FIG. 6A, these controls can be displayed in the messaging application next to the message used to generate the controls.

In step 510, the method can include selecting an action control from the displayed controls. In some implementations, the user may tap, click, or otherwise select an action control.

In step 512, in response, the method can include generating a subsequent LLM prompt based on the selected action control. In some implementations, step 512 can include loading the corresponding template (discussed above) and interpolating the required data (e.g., entity, message, etc.) as discussed above. Then, the method can input the subsequent LLM prompt into an LLM to receive a response. The format of the response may vary depending on the subsequent LLM prompt.

In step 514, the method can include displaying an answer or taking action. The specific choice will be dependent on the response of the LLM and the corresponding action. For example, actions such as calendaring a date or creating a task list item may cause the messaging application to make a call to the appropriate application using the data output by the LLM. Thus, the messaging application may not display the underlying LLM output but may instead immediately attempt to create the requested data structure. In some implementations, the messaging application may still format and display the data structure to obtain consent before proceeding. As another example, the output of the LLM may comprise a text string (e.g., in response to an entity prompt). In such a scenario the messaging application may output the LLM output to a chat interface.

FIG. 6B illustrates such an interface. Here, the user has selected the “Summary” action which cause the LLM to summarize the message and the messaging application outputs the summary to a chat interface (“You have a confirmed . . . ”). As illustrated, the chat interface also allows for free-form LLM prompts (“What kind of tourist activities can I do there?”) and also supports displaying controls directly in the chat window.

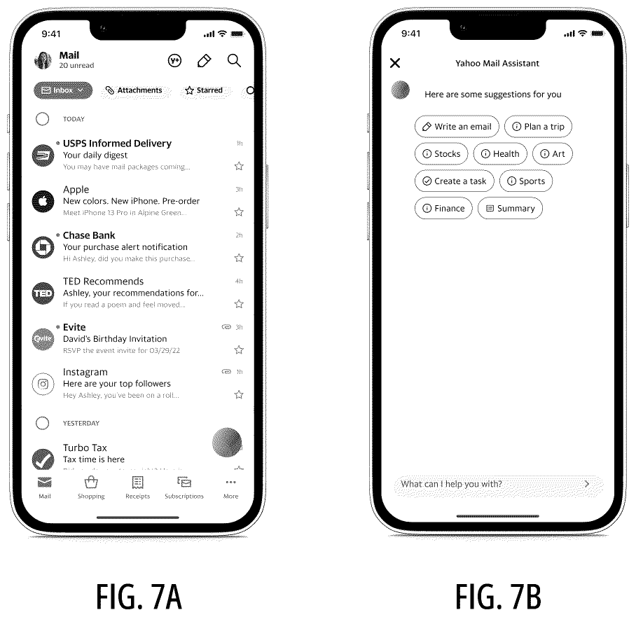

The foregoing method may also be extended to operate on multiple messages. This scenario is illustrated in FIGS. 7A and 7B. Here, a user can view their inbox or other message inbox and can select a control (illustrated as a circle in the lower right) to obtain actions. In response to selecting this control, a chat window (FIG. 7B) is displayed which lists the actions and/or entities. The user may then select these controls to generate subsequent LLM prompts as discussed. In this scenario, various steps of FIG. 5 may be modified.

First, step 502 may include receiving multiple messages. In some implementations, additional data beyond messaging data may be used. For example, news stories, financial data, or similar data of interest to a user may be included. In some implementations, the method can operate on all received messages or a subset thereof (e.g., only those received in the last twelve hours). Then, step 504 may be modified to include the content of all the selected messages in the initial LLM prompt to identify actions. Details of providing multiple messages in an LLM prompt were provided above. Next, step 508 may be preceded with a step of detecting interaction with a single control (FIG. 7A) which causes the display of a chat window (FIG. 7B) before displaying the action controls. With these modifications, a user can quickly obtain actions to perform on an entire inbox in a single interaction.

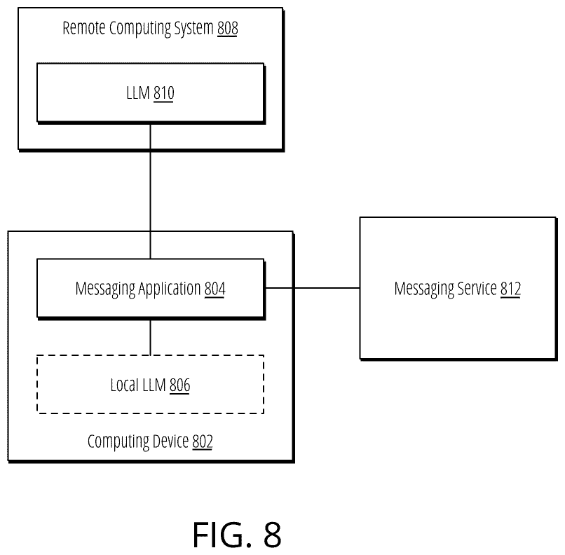

FIG. 8 is a block diagram illustrating a computing system according to some of the example embodiments.

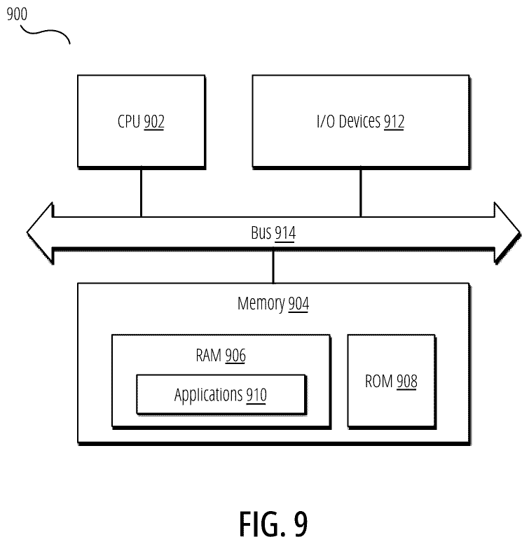

In an implementation, a computing device 802 is communicatively coupled to a remote computing system 808 and a messaging service 812. In an implementation, the computing device 802 can include a messaging application 804 and (optionally) a local LLM 806. In some implementations, the remote computing system 808 may include a LLM 810. In some implementations, the computing device 802 can comprise any type of general-purpose or special-purpose computing device. For example, computing device 802 may comprise a laptop or desktop computing device or a mobile computing device. Specific hardware details of computing device 802 (and, indeed, remote computing system 808 and messaging service 812) are described more fully in FIG. 9. In some implementations, messaging application 804 may comprise a mobile messaging application. In other implementations, messaging application 804 may comprise a desktop or other native application. In other implementations, the messaging application 804 may comprise a web-based application running within a web browser. As discussed above, the messaging application 804 may perform the methods described above and those details are not repeated herein.

As illustrated, the system includes a remote LLM (LLM 810) and an optional local LLM 806. One or both of these LLMs may be used as the LLM described in the foregoing methods. In some implementations, LLM 810 may be used exclusively and inputs to the LLM may comprise network calls to remote computing system 808. Alternatively, if local LLM 806 is used, it may be used as the LLM and prompts may be input locally. In some implementations, a combination of local and remote LLMs may be used and the choice of which may be governed by the network latency and/or predictive power of the respective LLMs.

Finally, the system includes messaging service 812 which may provide message data to computing device 802 and to messaging application 804. Messaging service 812 may include various services such as a message service, calendar service, task service, etc. to implement various functionalities to support the methods described above. Specific operations of messaging service 812 are not described in detail herein.

FIG. 9 is a block diagram of a computing device according to some embodiments of the disclosure.

As illustrated, the device 900 includes a processor or central processing unit (CPU) such as CPU 902 in communication with a memory 904 via a bus 914. The device also includes one or more input/output (I/O) or peripheral devices 912. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 902 may comprise a general-purpose CPU. The CPU 902 may comprise a single-core or multiple-core CPU. The CPU 902 may comprise a system-on-a-chip (SoC) or a similar embedded system. In some embodiments, a graphics processing unit (GPU) may be used in place of, or in combination with, a CPU 902. Memory 904 may comprise a memory system including a dynamic random-access memory (DRAM), static random-access memory (SRAM), Flash (e.g., NAND Flash), or combinations thereof. In one embodiment, the bus 914 may comprise a Peripheral Component Interconnect Express (PCIe) bus. In some embodiments, the bus 914 may comprise multiple busses instead of a single bus.

Memory 904 illustrates an example of a non-transitory computer storage media for the storage of information such as computer-readable instructions, data structures, program modules, or other data. Memory 904 can store a basic input/output system (BIOS) in read-only memory (ROM), such as ROM 908 for controlling the low-level operation of the device. The memory can also store an operating system in random-access memory (RAM) for controlling the operation of the device.

Applications 910 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 906 by CPU 902. CPU 902 may then read the software or data from RAM 906, process them, and store them in RAM 906 again.

The device may optionally communicate with a base station (not shown) or directly with another computing device. One or more network interfaces in peripheral devices 912 are sometimes referred to as a transceiver, transceiving device, or network interface card (NIC).

An audio interface in peripheral devices 912 produces and receives audio signals such as the sound of a human voice. For example, an audio interface may be coupled to a speaker and microphone (not shown) to enable telecommunication with others or generate an audio acknowledgment for some action. Displays in peripheral devices 912 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 912 may comprise any input device arranged to receive input from a user. An illuminator in peripheral devices 912 may provide a status indication or provide light. The device can also comprise an input/output interface in peripheral devices 912 for communication with external devices, using communication technologies, such as USB, infrared, Bluetooth®, or the like. A haptic interface in peripheral devices 912 provides tactile feedback to a user of the client device.

A GPS receiver in peripheral devices 912 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

These computer program instructions can be provided to a processor of a general purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure a computer readable medium (or computer-readable storage medium) stores computer data, which data can include computer program code or instructions that are executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
displaying, by a processor, a chat interface within a messaging application;
receiving, by the processor, a message goal from a user via the chat interface;
generating, by the processor, a large language model (LLM) prompt using the message goal;
inputting, by the processor, the LLM prompt into an LLM;
receiving, by the processor, generated text from the LLM responsive to the LLM prompt;
displaying, by the processor, the generated text as a proposed message in the chat interface; and
sending, by the processor, the proposed message to a recipient.

2. The method of claim 1, further comprising revising the proposed message in response to a user input before sending the proposed message.

3. The method of claim 1, wherein generating the LLM prompt further comprises:
parsing the message goal to identify prompt keywords; and
augmenting the LLM prompt with the prompt keywords.

4. The method of claim 1, wherein the LLM prompt includes data defining an output format for the generated text.

5. The method of claim 1, wherein the proposed message comprises one of an email message, a short message service (SMS) message, or a chat message.

6. The method of claim 1, wherein the chat interface includes a text input to allow the user to issue subsequent LLM prompts to revise the proposed message.

7. The method of claim 1, wherein the chat interface includes a button input to allow the user to issue subsequent LLM prompts to revise the proposed message based on pre-defined goals.

8. A non-transitory computer-readable storage medium for tangibly storing computer program instructions capable of being executed by a computer processor, the computer program instructions defining steps of:
displaying, by a processor, a chat interface within a messaging application;
receiving, by the processor, a message goal from a user via the chat interface;
generating, by the processor, a large language model (LLM) prompt using the message goal;
inputting, by the processor, the LLM prompt into an LLM;
receiving, by the processor, generated text from the LLM responsive to the LLM prompt;
displaying, by the processor, the generated text as a proposed message in the chat interface; and
sending, by the processor, the proposed message to a recipient.

9. The non-transitory computer-readable storage medium of claim 8, further comprising revising the proposed message in response to a user input before sending the proposed message.

10. The non-transitory computer-readable storage medium of claim 8, wherein generating the LLM prompt further comprises:
parsing the message goal to identify prompt keywords; and
augmenting the LLM prompt with the prompt keywords.

11. The non-transitory computer-readable storage medium of claim 8, wherein the LLM prompt includes data defining an output format for the generated text.

12. The non-transitory computer-readable storage medium of claim 8, wherein the proposed message comprises one of an email message, a short message service (SMS) message, or a chat message.

13. The non-transitory computer-readable storage medium of claim 8, wherein the chat interface includes a text input to allow the user to issue subsequent LLM prompts to revise the proposed message.

14. The non-transitory computer-readable storage medium of claim 8, wherein the chat interface includes a button input to allow the user to issue subsequent LLM prompts to revise the proposed message based on pre-defined goals.

15. A device comprising:
a processor;
a storage medium for tangibly storing thereon program logic for execution by the processor, the program logic comprising steps for:
displaying, by the processor, a chat interface within a messaging application;
receiving, by the processor, a message goal from a user via the chat interface;
generating, by the processor, a large language model (LLM) prompt using the message goal;
inputting, by the processor, the LLM prompt into an LLM;
receiving, by the processor, generated text from the LLM responsive to the LLM prompt;
displaying, by the processor, the generated text as a proposed message in the chat interface; and
sending, by the processor, the proposed message to a recipient.

16. The device of claim 15, further comprising revising the proposed message in response to a user input before sending the proposed message.

17. The device of claim 15, wherein generating the LLM prompt further comprises:
parsing the message goal to identify prompt keywords; and
augmenting the LLM prompt with the prompt keywords.

18. The device of claim 15, wherein the LLM prompt includes data defining an output format for the generated text.

19. The device of claim 15, wherein the chat interface includes a text input to allow the user to issue subsequent LLM prompts to revise the proposed message.

20. The device of claim 15, wherein the chat interface includes a button input to allow the user to issue subsequent LLM prompts to revise the proposed message based on pre-defined goals.
